(19) United States
(12) Patent Application Publication
(10) Pub. No.: US 2004/0004703 A1
(43) Pub. Date: Jan. 8, 2004

(54) Method and apparatus for reducing rotary stiffness in a support mechanism

(76) Inventor: Andrew J. Hazelton, San Carlos, CA (US)

Correspondence Address: LAW OFFICES OF LELAND WIESNER, 1144 FIFE AVE., PALO ALTO, CA, 94301, US

(21) Appl. No.: 10/188,661

(22) Filed: Jul. 2, 2002

(51) Int. Cl. G03B 27/58

(52) U.S. Cl. 355/72; 355/53; 355/76; 378/34; 310/10

(57) ABSTRACT

A support device for a stage provides flexibility in at least two degrees of freedom. The support device uses a mounting device with stiffness in at least a first degree of freedom and rotational flexibility in a second degree of freedom, capable of receiving the stage device. An extension device configured to extend from a base and affix to the mounting device has flexibility in at least the first degree of freedom and rotational stiffness in the second degree of freedom. This support device can be used in precision manufacturing including lithographic processing. Rotational flexibility in the mounting device is facilitated using at least two flexures arranged at angles to each other and capable of providing rotational flexibility in the second degree of freedom and stiffness in at least the first degree of freedom. Materials in the flexures include metallic, non-metallic and composite materials.

### CROSS REFERENCE TO RELATED APPLICATIONS

This application is related to PCT International Application No.00/10831 of Nikon Corporation filed Apr. 21, 2000 entitled “Wafer Stage with Magnetic Bearings” incorporated by reference herein in the entirety for all purposes.

### TECHNICAL FIELD

This invention relates to a method and apparatus for reducing the rotary stiffness in a support mechanism used in precision manufacturing.

### BACKGROUND ART

Precision manufacturing requires accurately controlling the movement of a workpiece during each step of the manufacturing process. Typically, the workpiece is mounted on one or more stages that position the workpiece while the various manufacturing steps are performed. A coarse stage can be used to move the workpiece larger distances while a fine stage supported by the coarse stage moves the workpiece relatively shorter distances. Unfortunately, there is less tolerance for errors as increasing trends in miniaturization require higher accuracy in moving the workpiece through the manufacturing process. Inaccurately positioning the workpiece during manufacturing can result in a workpiece that fails to work properly or has decreased operational reliability. This is particularly true in integrated circuit design and development where photolithography and other precision processes are used to place a large number of transistors closely together on a wafer. Small errors in positioning the one or more stages supporting the wafer can result in lower yields and higher microprocessor manufacturing costs.

A number of different factors can cause these positioning errors. Movement of the stage can introduce vibrations and move a wafer or other workpiece out of alignment. Further, heat generated by the stage and other mechanisms can cause the stage to expand and make precision measurements with an interferometer system difficult or inaccurate. Consequently, the support for a stage should be flexible in the direction of movement to dampen vibration and release a minimal amount of heat into the manufacturing environment.

In the past, voice-coil motor (VCM) technology has been used to support and control the stages during precision manufacturing. The VCM is advantageous as the force generated by the VCM is independent of the stage position. While this independence reduces the complexity of supporting and moving the stage, operating the VCM requires large amounts of energy that dissipates into the surrounding environment as heat. Heat generation can cause errors in alignment and control as the stage and other portions of the wafer tend to expand and contract. The heat can also change the index of refraction in an interferometer system causing inaccurate measurements and readings.

Air-bellows have also been used to support and control the stage in a manufacturing environment. The air-pressure introduced into the air-bellows supports the stage and can be changed to move the stage into the proper position. Unlike the VCM, the change in air pressure within the air-bellows does not introduce heat into the stage and other parts of the manufacturing environment. By design, the air-bellows is flexible in several degrees of freedom namely the X, Theta X, Y, Theta Y, and Z degrees of freedom. However, the air-bellows does not tend to be flexible in the Theta Z direction (i.e. rotation about the Z-axis) and therefore does not damp vibration well in this direction.

### SUMMARY OF THE INVENTION

One aspect of the invention features a support device having a mounting device and an extension device combination providing flexibility in at least two degrees of freedom. In general, the support device can be used in precision manufacturing including lithographic processing. The mounting device portion of the support device provides stiffness in at least a first degree of freedom and rotational flexibility in the second degree of freedom and is capable of receiving a stage device. The stage device can be one of many different types of stage devices including either a fine or coarse stage device. The extension device portion configured to extend from a base and affix to the mounting device has flexibility in at least the corresponding first degree of freedom and rotational stiffness in the second degree of freedom. For example, the extension device may be a bellows with stiffness in the Theta Z degree of freedom.

In a further aspect of the invention, rotational flexibility in the mounting device is facilitated using at least two flexures arranged at angles to each other and capable of providing rotational flexibility in the second degree of freedom and stiffness in at least the first degree of freedom. The flexures used on the mounting device can include metallic, non-metallic or composite materials.

In another aspect of the invention, the rotational flexibility of the mounting device is facilitated using a rotational air-bearing, or a diaphragm in addition to the extension device. Both of these mounting devices are capable of providing rotational flexibility in the second degree of freedom and stiffness in at least the first degree of freedom. Again, this complements the rotational stiffness of the extension device coupled to the mounting device portion.

Advantageous implementations of the invention include one or more of the following features. Increased rotational flexibility in the support device by affixing a mounting device to an extension device such as a bellows. The mounting device provides additional flexibility in the rotational degree of freedom yet remains stiff in other degrees of freedom. The mounting device in the support device can be interchanged with different types of extension devices for added versatility. The mounting device using flexures or a rotational air bearing can be used with a bellows extension device, a spring extension device or a diaphragm extension device. The design and manufacturing of the support device is efficient and effective for use with precision manufacturing such as microlithography.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a schematic view illustrating a photolithographic instrument incorporating a wafer positioning stage in accordance with principles of the present invention;

FIG. 2 is a perspective view of a stage system according to principles of the present invention;

FIG. 3 is a perspective view of an upper portion of the stage system shown in FIG. 2, emphasizing the finely controlled stage;

FIG. 4 is another perspective view of the fine stage mounted on the coarse stage according to principles of the present invention;

FIG. 5A is a top view of the fine stage mounted on the coarse stage;

FIG. 5B depicts schematic vertical cross-sectional view of an electromagnetic actuator device controlling the position of the fine stage in the vertical direction;

FIG. 6A is a schematic view of a bellows using flexures to support a wafer table in accordance with principles of the present invention;

FIG. 6B is a top view of the flexures affixed to the bellows in FIG. 6A in accordance with principles of the present invention;

FIG. 6C is a schematic view of a bellows using a rotational air-bearing in accordance with the present invention;

FIG. 6D is a schematic view of a diaphragm using flexures to support a wafer table in accordance with principles of the present invention;

FIG. 6E is a schematic view of a diaphragm using a rotational air-bearing to support a wafer table in accordance with principles of the present invention;

FIG. 7 is a perspective view of a lithography system according to principles of the present invention;

FIG. 8 is a schematic describing the sensing and control functions of the present device;

FIG. 9 is another schematic view illustrating a photolithographic instrument incorporating an additional embodiment of a wafer stage according to principles of the present invention;

FIG. 10 is a flow chart that outlines a process for manufacturing a device in accordance with principles of the present invention; and

FIG. 11 is a flow chart that outlines device processing in more detail.

### DETAILED DESCRIPTION

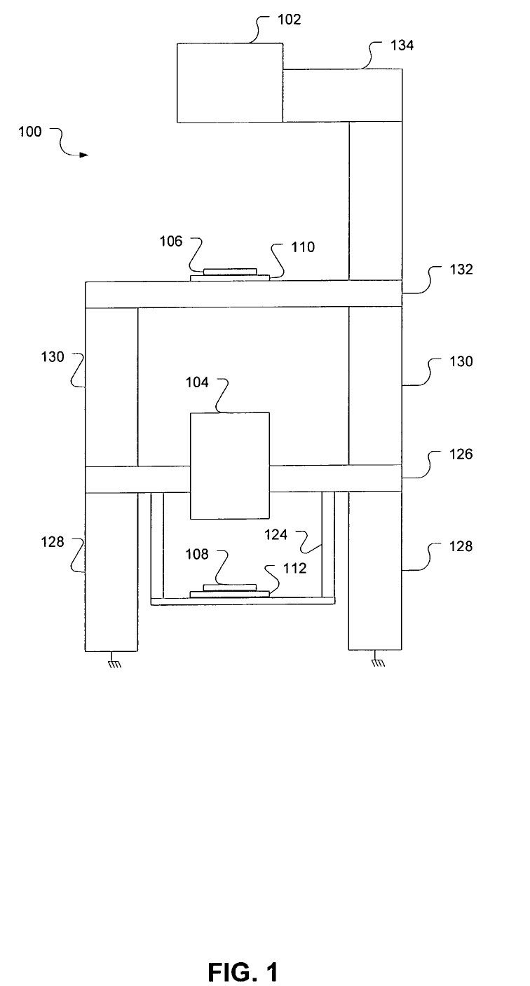

A brief description of a photolithographic instrument will be given here as background for use of the precision control stage according to principles of the present invention. FIG. 1 is a schematic view illustrating a photolithographic instrument 100 incorporating a wafer positioning stage driven by a linear motor coil array or planar motor coil array in accordance with the principles of the present invention. Photolithographic instrument 100 generally comprises an illumination system 102 and at least one linear or planar motor for wafer support and positioning. Illumination system 102 projects radiant energy (e.g. light) through a mask pattern (e.g., a circuit pattern for a semiconductor device) on a reticle (mask) 106 that is supported by and scanned using a reticle stage (mask stage) 110. Reticle stage 110 is supported by a frame 132. The radiant energy is focused through a projection optical system (lens system) 104 supported on a frame 126, which is in turn anchored to the ground through a support 128. Optical system 104 is also connected to illumination system 102 through frames 126, 130, 132 and 134. The radiant energy exposes the mask pattern onto a layer of photoresist on a wafer 108.

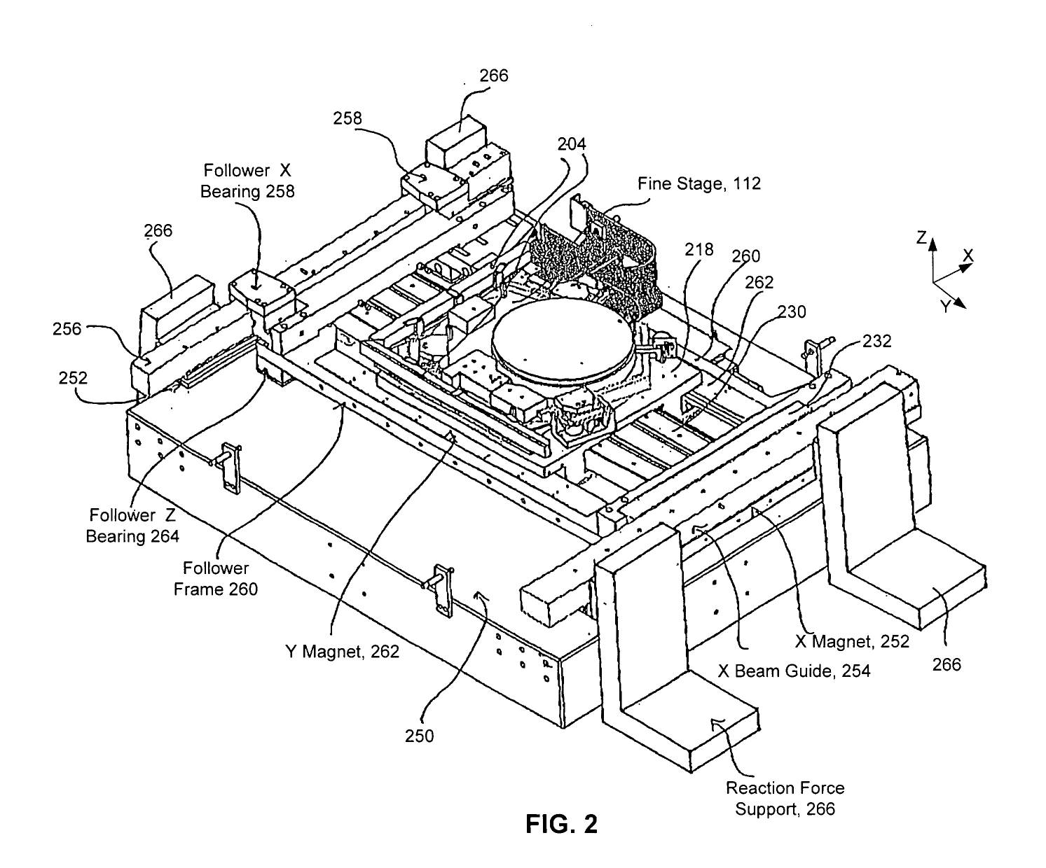

Wafer (object) 108 is supported by and scanned using a fine wafer stage 112. Fine stage 112 is limited in travel to about 400 microns total stroke in each of the X and Y directions. Referring to FIG. 2, fine stage 112 is in turn supported by a lower stage (supporting stage) 218. Lower stage 218 has a much longer stroke and is used for coarse positioning. For example, lower stage 218 is substantially aligned with the optical system 104. As shown in FIG. 2, lower stage 218 translates in the Y direction along a beam 230, by pushing on a follower frame 260. The follower frame 260 and beam 230 move together in the X direction along X beam guide 254 and X follower guide 256. The entire assembly is guided in the Z direction by a base 250. Base 250 provides a smooth surface for the Z bearings, which are preferably air bearings, to ride upon. Base 250 is preferably formed of granite or other very planar and very dimensionally stable material. Thus, the Z bearings guide movements of the entire assembly to remain constant in the Z direction (X-Y plane).

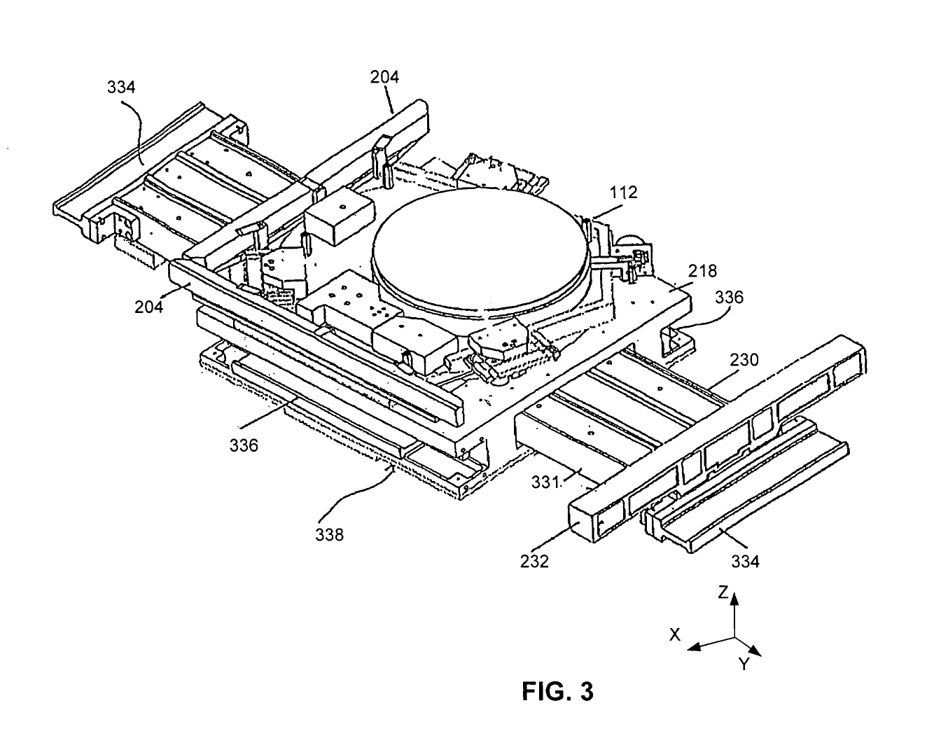

Beam 230 runs through the center of lower stage 218 (FIG. 3), and has a flat, smooth and preferably polished guide surface 331 that guides the lower stage as it moves in the Y direction. Air bearings are preferred for guiding the lower stage 218 along the guide surface 331 to permit low friction movement of the lower stage 218 along the beam 230. Although not shown, at least one air bearing is preferably attached to the inside of lower stage 218 opposing guide surface 331. Z air bearings 338 are attached to the base of lower stage 218 to guide the stage motion in the plane. Electromagnetic motor coils 334 are provided at opposite ends of beam 230. X magnets 252 (FIG. 2) are provided to interact with motor coils 334 to provide the driving force for beam 230 and follower frame 260 in the X direction. Thus, linear motors are preferred as shown by the motor coils and magnets, but other alternative drives could be employed, although not as preferred, such as screw drives, rotary motors or other planar force motors, such as those described in copending U.S. patent application Ser. No. 09/192,637, filed on Nov. 16, 1998, and entitled “A Platform Positionable In At Least Three Degrees Of Freedom By Interaction With Coils.” incorporated herein by reference in its entirety by specific reference thereto. Examples of photolithographic instruments that may incorporate a linear or planar motor of the present invention are described in Nakasuji, U.S. Pat. No. 5,773,837; Nishi, U.S. Pat. No. 5,715,037; and Lee, U.S. Pat. No. 5,528,118, all of which are incorporated herein by reference in their entireties.

An X beam guide 254 and an X beam or follower guide 256 are aligned above respective X magnets 252, as shown in FIG. 2. A linear bearing 232, which is preferably a vacuum preloaded air bearing, is provided adjacent an X motor coil 334 (FIG. 3). Upon insertion of the X motor coils 334 into the slots provided in X magnets 252 therefore, the linear bearing 232 closely approximates the guide surface of X beam guide 254, where the guide surface is provided with a very smooth surface against which the air bearing rides for guidance of X beam 230 in the X direction. Follower frame 260 is guided in the X direction via the attachment to X follower guide 256 through X follower bearings 258, which are also preferably air bearings. Follower Z bearings 264, also preferably an air bearing, rides along base 250 and supports the follower frame 260 in the Z direction. X beam 230 is actuated in the X direction through X motor coils 334. Lower stage 218 being mounted on X beam 230 follows the motion. Although X beam 230 as described above does not move in the Y direction, an alternate implementation of the invention can be configured with X beam 230 moving in the Y direction. In this alternate implementation, there is a possibility that yawing will occur as X beam 230 moves in the Y direction. Accordingly, the output from the linear motors located at both ends of the X beam 230 can be suitably distributed to correct for potential yawing.

Y motor coils 336 in FIG. 3 are provided on opposite sides of the lower stage 218 for insertion within the slots provided in Y magnets 262 which are mounted to follower frame 260 parallel to the Y axis. Actuation of Y motor coils 336 within Y magnets 262 motivates Y motor coils 336 to drive lower stage 218 in Y direction with respect to X beam 230. Lower stage 218 is guided along guide surface 331 of X beam 230, during Y direction movements, by the air bearing (not shown) attached to the inside of the lower stage opposite the guide surface 331.

As shown in FIG. 2, both X magnets 252, as well as X beam guide 254 and X beam follower guide 256 are mounted to reaction force supports 266, which are mounted directly to ground and which do not contact base 250. Therefore, when the X motor coils are actuated to provide a driving force in the X direction, the equal and opposite force that is generated is applied against the reaction force supports 266 and transferred to ground without disturbing the base 250. Likewise, when the Y motor coils 336 are actuated to push on the Y magnet tracks 262, the equal and opposite reaction forces generated thereby are applied against the reaction force supports 266 and transferred to ground, without disturbing the base 250. In this manner, all forces in the X and Y directions acting on either the follower frame 260 or the beam 230 are connected directly to ground through the reaction force supports 266, and do not couple with the base 250.

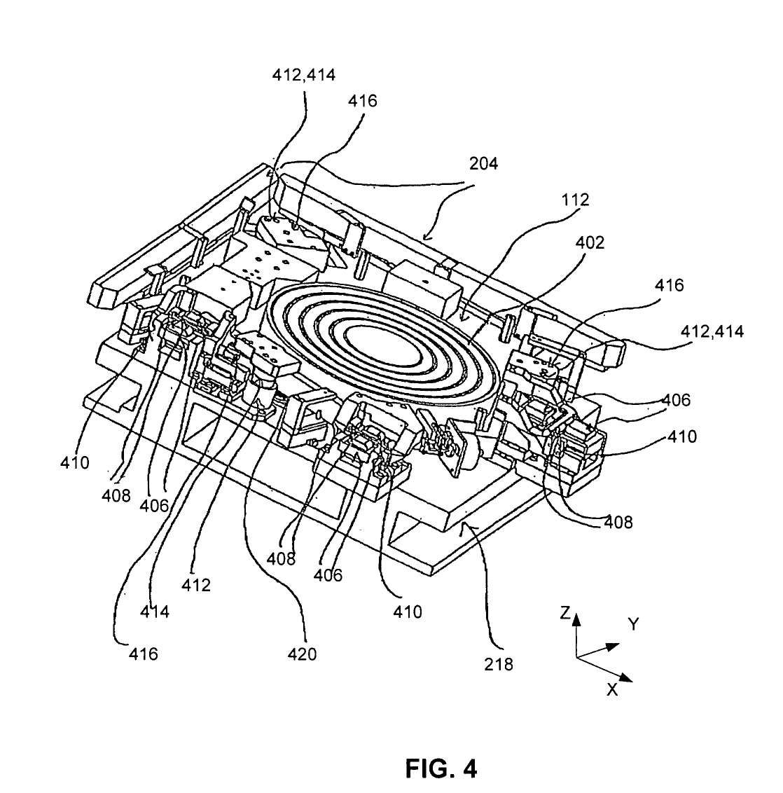

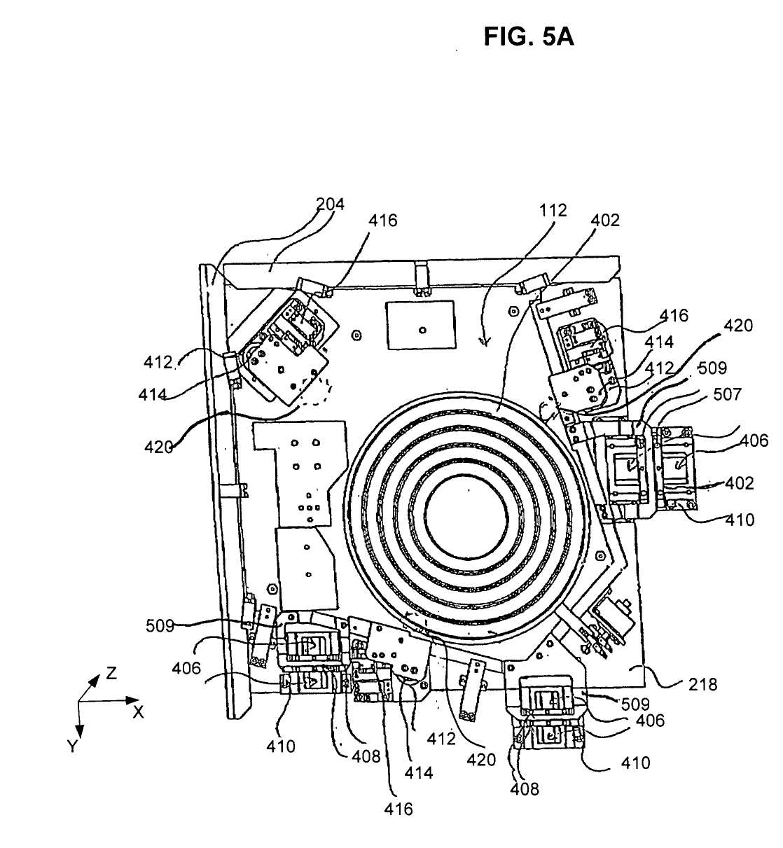

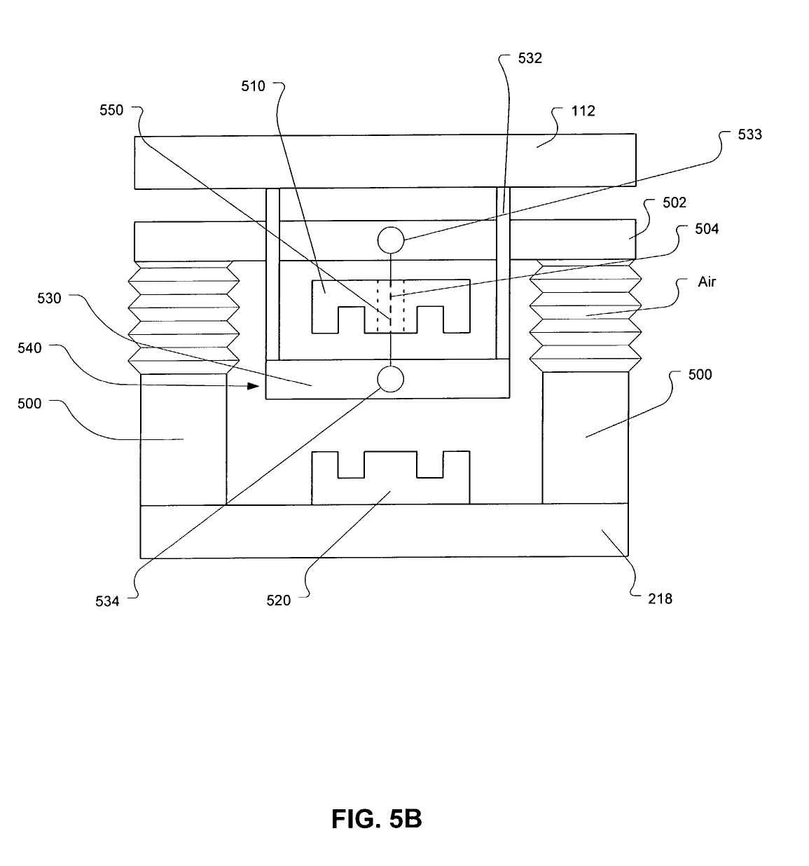

Fine stage 112 is mounted to lower stage 218 for small and precise movements in the X, Theta X, Y, Theta Y, Z and Theta Z (i.e. rotation in the X-Y plane) directions, as shown in FIGS. 4 and 5. Fine stage 112 includes a wafer (holding portion) on which a wafer can be mounted for precise positioning. Mirrors 204 are mounted on fine stage 112 and aligned with the X and Y axes. Mirrors 204 provide reflective reference surfaces off of which laser light is reflected to determine a precise X-Y position of fine stage 112 using a laser interferometer system as a position detection device.

Referring to FIG. 4, the position of fine stage 112 in three planar degrees of freedom, X, Y and Theta Z, is actuated using three pairs of electromagnets 406(actuating portions) that are mounted to the lower stage 218. Electromagnets 406 are preferably formed as E-shaped laminated cores made of silicon steel or preferably Ni—Fe steel, that each have an electrical wire winding around the center section. Electromagnetic targets 408 (relative moving portions), preferably in the form of an I-shaped piece of magnetic material, and preferably made up of the same material or materials used to make the corresponding E-shaped laminated cores, are placed oppositely each of electromagnets 406, respectively. Each electromagnet 406 and electromagnetic target 408 is separated by an air gap g (which is very small and therefore difficult to see in the figures). Electromagnets 406 are variable reluctance actuating portions and the reluctance varies with the distance defined by the gap g, which, of course also varies the flux and force applied to the target 408. The attractive force between the electromagnet and the target is defined by:

F=K(i/g)²

where

F is the attractive force, measured in Newtons;

K=an electromagnetic constant which is dependent upon the geometries of the E-shaped electromagnet 406, I-shaped target 408 and number of coil turns about the magnet;

i=current, measured in amperes;

and g=the gap distance, measured in meters and

K=1/2N² μₒ wd;

where

N=the number of turns about the E-shaped magnet core 408;

μₒ=a physical constant of about 1.26×10⁻⁶ H/m;

w=the half width of the center of the E-shaped core 408 in meters; and

d=the depth of the center of the E-shaped core 408 in meters.

In a preferred embodiment, K=7.73×10⁻⁶ kg m³/s²A²;

When the coil of an electromagnet is energized, the electromagnet 406 generates a flux producing an attractive force on electromagnetic target 408 in accordance with the formula given above. Because the electromagnets 406 attract targets 408, they are assembled in pairs that pull in opposition. Electromagnetic targets 408 are fixed to fine stage 112 that moves relative to the lower stage 218. Opposing pairs of electromagnets 406 are fixed on the relatively non-moveable (with respect to controlling movements of the fine stage 112) lower stage 218 on opposite sides of electromagnetic targets 408. Thus, by making a flux generated by one of the electromagnets to be larger than the flux generated by the other in the pair a differential force can be produced to draw the targets in one direction or its opposing direction.

Electromagnets 406 corresponding to electromagnetic targets 408 are attached to the fine stage 112 in such a way that the pulling forces of the opposing pair of electromagnets 406 do not distort fine stage 112. This is preferably accomplished by mounting electromagnetic targets 408 for an opposing pair of electromagnets 406 very close to one another, preferably peripherally of the fine stage 112. Most preferred is to extend a thin web 509 of material as illustrated in FIG. 5A, which is preferably made of the same material that fine stage 112 is made of, preferably ceramic, such as silicon carbide or alumina, for example, from the periphery of fine stage 112, onto which the electromagnetic targets 408 are mounted. The opposing electromagnets 406 are mounted on the lower stage 218 by a predetermined distance so that when the web 509 and targets 408 are positioned therebetween, a predetermined gap g is formed between each set of electromagnet 406 and target 408. With this arrangement, only the resultant force, derived from the sum of the forces produced by the pair of electromagnets 406 and targets 408, is applied to fine stage 112 via transfer of the force through web 509. In this way, opposing forces are not applied to opposite sides of the stage and stage distortion problems resulting from that type of arrangement are avoided.

In the above-described arrangement, each pair of electromagnetic actuator devices is comprised of two actuating portions (electromagnets 406) and two moving portions (targets 408). However, the present invention is not restricted to this configuration. For example, the invention can use a combination of two actuating portions (electromagnets) and one moving portion (target). In this instance, the web 509 is provided with only one moving portion (target 408), and the moving portion (target 408) is interposed between two actuating portions (electromagnets 406) located on both sides with a specific gap therebetween.

FIG. 5A shows an arrangement of the electromagnets 406 and targets 408 in which one opposing pair is mounted so that the attractive forces produced thereby are substantially parallel with the X direction of the stage. Two opposing pairs are mounted so that attractive forces from each pair are produced substantially parallel with the Y direction of the stage. With this arrangement, control of three degrees of freedom of the fine stage 112 can be accomplished, namely fine movements in the X, Y and Theta Z directions. Of course, two opposing pairs could be mounted parallel with the X direction and one pair parallel with the Y direction, to work equally as well as the shown arrangement. Other arrangements are also possible, but this arrangement minimizes the number of actuating portions/bearings required for the necessary degrees of control.

Typically, the lines of force of the actuating portions are arranged to act through the center of gravity (CG) of fine stage 112. The two Y actuating portions are typically equidistant from the CG.

Actuation of the single pair of electromagnets 406 can achieve fine movements in either X direction. Actuation of the two pairs of electromagnets aligned along the Y axis can control fine movements of fine stage 112 in either Y direction, or in rotation (clockwise or counterclockwise) in the X-Y plane (i.e., Theta Z control). Y-axis movements are accomplished by resultant forces from both pairs that are substantially equal and in the same direction. Theta Z movements are generally accomplished by producing opposite directional forces from the two pairs of electromagnets, although unequal forces in the same direction will also cause some Theta Z adjustment.

Short-range sensors 410 illustrated in FIG. 5A measure the distance between fine stage 112 and the lower stage 218 in the three planar degrees of freedom. Fine stage 112 is also levitated in the three vertical degrees of freedom, Z, Theta X and Theta Y. Because control in the three vertical degrees of freedom requires less dynamic performance (e.g., acceleration requirements are relatively low) and is easier to accomplish, lower force requirements exist than in the previously described X, Y and Theta Z degrees of freedom. Thus, the use of three VCM (voice coil motor) magnets 412 attached to the lower stage 218 and three VCM coils attached to fine stage 112 are satisfactory for the vertical levitation. The relative position in the three vertical degrees of freedom is measured using three linear sensors 416. To prevent overheating of the VCM coils 414, the dead weight of fine stage 112 supported by air bellows 420. Preferably, three air bellows are employed and respectively located next to the VCMs. The bellows 420 have very low stiffness in all degrees of freedom so they do not significantly interfere with the control of fine stage 112.

In an alternative implementation, a combination of air bellows and wire as illustrated in FIG. 5B can be used to support the fine stage 112. This implementation supports fine stage 112 by a suspending bar 502 and pair of air bellows 500. Air bellows 500 are filled with pressurized air to support suspending bar 502. Implementations of the present invention may use two air bellows 500 as illustrated or fewer or greater air bellows as needed by the particular design. A wire 504 couples suspending bar 502 to fine stage 112 through an electromagnetic actuator device 540 having a pair of limbs 532, an electromagnetic target 530, an E-shaped electromagnet 510, an E-shaped electromagnet 520, and one common I-shaped electromagnetic target 530 interposed between the two E-shaped electromagnets. Both upper electromagnet 510 and lower electromagnet 520 are rigidly mounted on the lower stage 218 (supporting portion for the upper electromagnet 510 is not shown in the figure). A vertical hole 550 formed within the upper electromagnet 510 allows wire 504 to extend from a first connection point 533 in suspending bar 502 to another connecting portion 534 in electromagnetic target 530.

The configuration and operation of the electromagnetic actuator device 540 are similar to those described in conjunction with FIG. 4 and FIG. 5A. Electromagnetic forces between electromagnet 520 and electromagnetic target 530 and between electromagnet 510 and electromagenetic target 530 are used to control movement of stage 112 in the vertical direction. These electromagnetic forces control the vertical direction movement applied to electromagnetic target 530 by electromagnetic actuator device 540 in consideration of the supplemental vertical force provided by the air bellows 500. Forces from both electromagnetic actuator device 540 and air bellows 500 are applied to the same location on electromagnetic target 530 and ultimately fine stage 112. This configuration allows both forces to act in opposition without deforming fine stage 112. For example, downward forces by electromagnetic actuator device 540 at the same location on the fine stage 112 meet extra upward forces on the fine stage 112 generated when air bellows 500 has too much air pressure. Undesirable deformation of fine stage 112 is avoided, in part, because the opposing forces are not applied to different locations of the fine stage 112.

This configuration also avoids problems arising from the lateral stiffness of the air bellows 500 and corresponding planar positioning of the fine stage 112. Suspending the fine stage 112 by a wire 504 facilitates more flexibility than possible with fine stage 112 directly supported by the air bellows 500. This allows electromagnetic target 530 make smaller horizontal and rotational motions given the position of the air bellows 500 or suspending bar 502 depicted in FIG. 5B. In an alternative implementation, a thin flexible rod can be used to replace wire 504 if the rod provides sufficient tension and is thin enough to flexibly support the fine stage 112.

Furthermore, electromagnetic actuator device 540 uses less power and generates less heat compared with voice coil motor solutions. The power efficiency can be further improved when the electromagnets 510, 520 use variable reluctance actuating portions that vary the reluctance with the distance defined by the gap between the electromagnets 510, 520 and the electromagnetic target 530. Additionally, electromagnetic actuator device 540 improves the dynamic performance of the fine stage 112 required in a system requiring relatively high acceleration characteristics.

Although the embodiment shown in FIG. 5B uses an electromagnetic actuator device 540 that has one common electromagnetic target 530 for electromagnetically coupling two electromagnets 510, 520, other configurations of the electromagnetic actuator device 540 are possible. For example, a pair of electromagnetic actuator devices, used for the planar control of the fine stage 112 in conjunction with FIG. 4 and FIG. 5B and described above, may replace a single electromagnetic actuator device 540 shown in FIG. 5B. In such a case, the wire 504 extending from the suspending bar 502 through a hole 550 formed within an upper electromagnetic actuator device of the pair may be connected only to the electromagnetic target of the upper electromagnetic actuator device.

As another example, it is possible to eliminate the upper electromagnet 510, leaving only one electromagnetic actuator device 540 comprising one electromagnet 520 and one electromagnetic target 530. In this case, the electromagnetic actuator device 520 can only pull down the fine stage 112 suspended by the bellows force. However, the configuration shown in FIG. 5B is preferable because it consumes less space, the electromagnetic force and the supplemental vertical force act on the same member of the electromagnetic actuator device, and the electromagnetic force can levitate the fine stage 112. It is also possible to replace the air bellows 500 by other supplemental vertical support including a permanent magnet or other mechanisms when the use of air bellows is not adequate.

Furthermore, the suspending bar 502 may not be necessary for carrying the bellows force to the fine stage 112. For example, the air bellows 500 may directly support the electromagnetic target 530, the limb 532, or the fine stage 112 at a location very close to the electromagnet 520 mounted on the lower stage 218. This configuration is easier to accomplish and still manages to have the supplemental vertical force acting on the same mechanical member, or at least the substantially same portion of the stage as the mechanical member, as the electromagnetic force does. However, the configuration shown in FIG. 5B is preferred as such a configuration reduces the lateral flexibility of the fine stage 112.

In one implementation depicted by FIG. 5A, vertical support mechanisms described above each comprise a combination of an electromagnetic actuator device 540 and the air bellows 500 and are disposed at three locations underneath the fine stage 112 denoted by three broken circles 420. Fine stage 112 is controllable in three vertical degrees of freedom, namely, Z axis movement, Theta X rotation, and Theta Y rotation. Alternate implementations may use fewer or greater than the three vertical support mechanisms used in this embodiment.

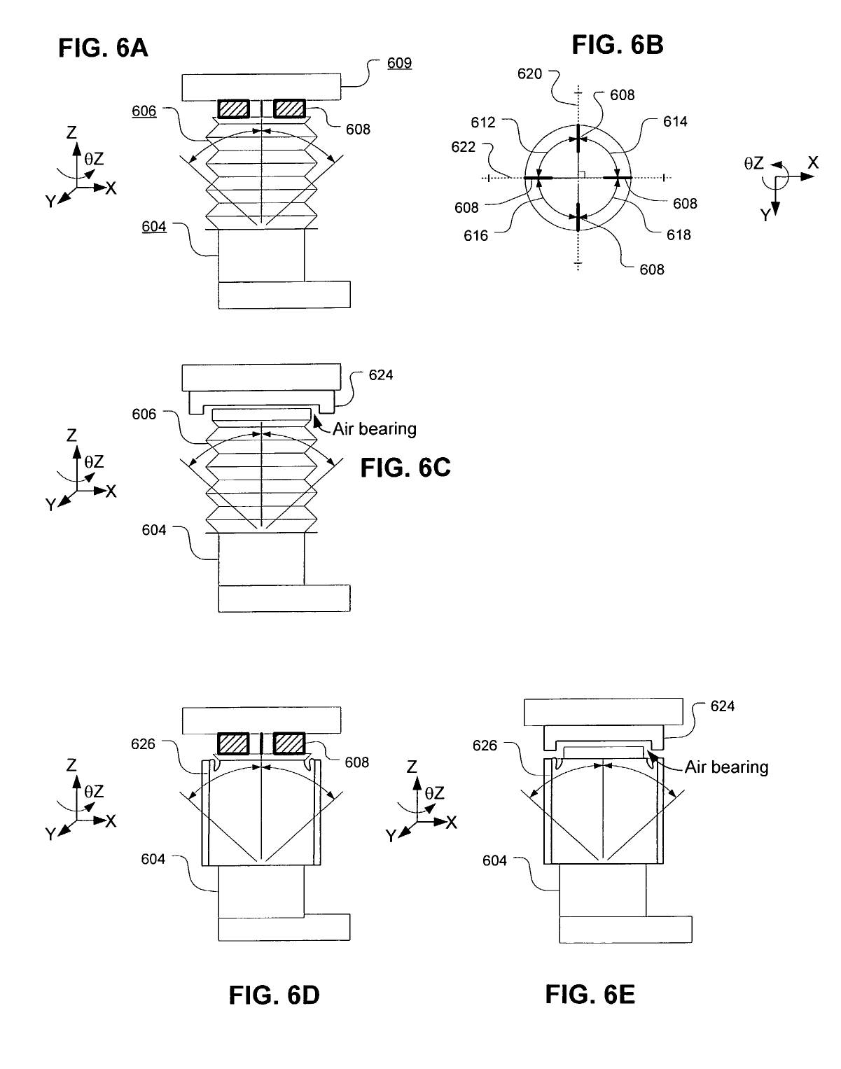

In yet another implementation, rotational stiffness in the Theta Z direction can be improved by modifying the support mechanisms underneath fine stage 112. FIGS. 6A through 6E depict various support mechanisms having reduced stiffness in accordance with aspects of the present invention. Each support mechanism uses a mounting device that receives the stage device and an extension device configured to extend from the base and affix to the mounting device. Generally, the mounting device provides stiffness in at least a first degree of freedom and rotational flexibility in a second degree of freedom. The stiffness of the mounting device in the first degree of freedom complements the flexibility characteristics of the extension device that has flexibility in at least the first degree of freedom but rotational stiffness in the second degree of freedom. For example, the mounting device can provide rotational flexibility in Theta Z while providing stiffness in the Theta X, X, Theta Y, Y and Z degrees of freedom. Meanwhile, the extension device provides flexibility in Theta X, X, Theta Y, Y and Z degrees of freedom but is stiff in the Theta Z degree of freedom.

As an example, FIGS. 6A and 6B provide a side view and top view respectively of a support mechanism using a mounting device with flexures 608 and a bellows extension device 606, hereinafter bellows 606. FIG. 6A illustrates bellows 606 and flexures 608 positioned between a base 604 and a wafer table 609. Bellows 606 extends from base 604 and is affixed to the underside of the mounting device having flexures 608. Air-pressure introduced into bellows 606 creates sufficient force to support wafer table 609, fine stage 112 and other related components described above. While supporting wafer table 609, bellows 606 remains flexible as illustrated by the arrows in FIG. 6A in Theta X, X, Theta Y, Y and Z degrees of freedom.

Flexures 608 affixed to the mounting device are used to improve rotational flexibility in bellows 606. Generally, at least two flexures can be used to support wafer table 609. In one implementation depicted in FIG. 6B, four flexures arranged orthogonal to each other are affixed to bellows 606. The face or plane of each flexure is flexible but is stiff laterally or along the edge of the material. Curved arrows in FIG. 6B indicate rotational flexibility among four flexures while the straight dotted lines indicate stiffness in the respective directions. For example, flexures 608 provide rotational flexibility in regions 612, 614, 616 and 618 however flexures 608 remain stiff laterally along x-axis 622 and y-axis 620. Depending on design requirements, flexures can be constructed from various combinations of metallic, non-metallic and composite materials including rubbers, plastics, and various alloys. Even after repeated use, the flexure should be able to maintain its original shape or substantially close to its original shape.

FIG. 6C illustrates another support mechanism consistent with the present invention using a rotational air bearing 624 and bellows 606. As described above, bellows 606 provides flexibility in several degrees of freedom but suffers from limited rotational flexibility along the Z axis (i.e., Theta Z). Instead of using flexures 608, air pressure separating rotational air bearing 624 from bellows 606 allows wafer table 609 to rotate independent of bellows 606 in the Theta Z degree of freedom. Like flexures 608 in FIGS. 6A and 6B, rotational air bearing improves flexibility in the Theta Z degree of freedom while maintaining relative stiffness in the other degrees of freedom. Accordingly, flexible air bearing 624 can also be used to increase rotational flexibility in a support mechanism using bellows 606 when flexures 609 are neither convenient nor desirable.

Additional support mechanisms having increased rotational flexibility are illustrated in FIGS. 6D and 6E. For example, FIG. 6D depicts using a diaphragm extension device 626, hereinafter diaphragm 626, with flexures 608. Diaphragm 626 can be a spring mechanism, rubber or another flexible material filled with air or liquid to support wafer table 609. The outer portion of diaphragm 626 is rigid and like bellows 606 has limited rotational flexibility around the Z-axis or Theta Z. As described above, flexures 608 on a mounting device and then affixed to the top portion of diaphragm 626 provide rotational flexibility in the Theta Z degree of freedom. Similarly, FIG. 6E illustrates using rotational air bearing 624 with diaphragm 626 to also increase rotational flexibility. Rotational air bearing 624 rotates freely on a cushion of air providing further flexibility in the Theta Z degree of freedom. Of course, in FIGS. 6A through 6E the size, shape and positioning of flexures 608 and rotational air bearing 624 may differ from those used with bellows 606 as diaphragm 626 will likely have different degrees of flexibility and stiffness in the various degrees of freedom when compared with bellows 606.

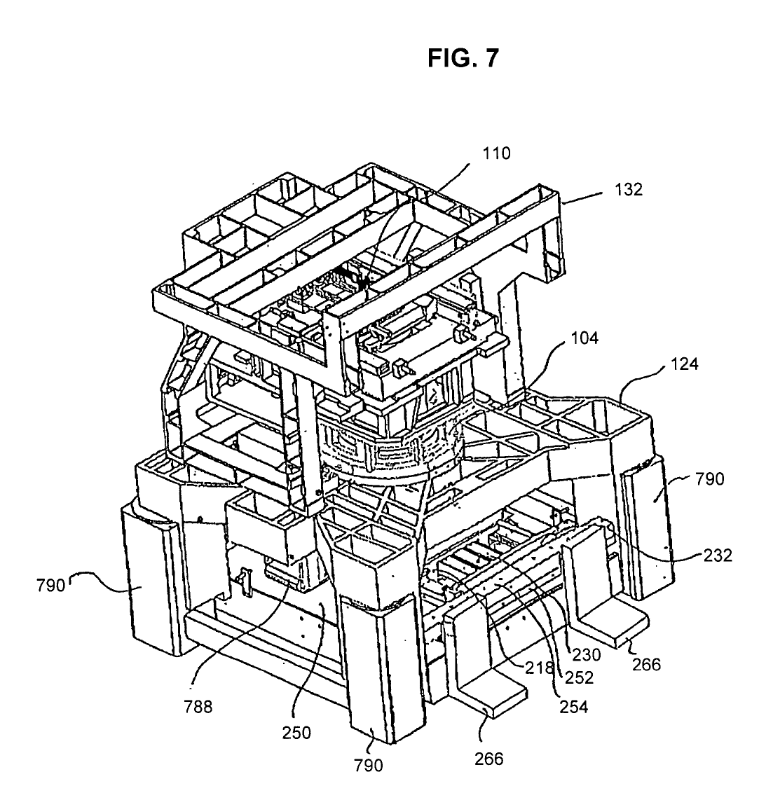

Now referring to FIG. 7, the base 250 is rigidly attached to the body 124. The complete body assembly is isolated from the ground by vibration isolators 790. Isolation mounts that are typically used are the “Electro-Damp Active Vibration Control System,” available from Newport Corporation of Irvine, Calif. The planar position of fine stage 112, relative to the lens 104, is measured using interferometers 788 which reflect laser light from interferometer mirrors 204, as illustrated in FIG. 2. The vertical position of the stage is measured using a focus and level sensor (not shown) that reflect light from the wafer surface.

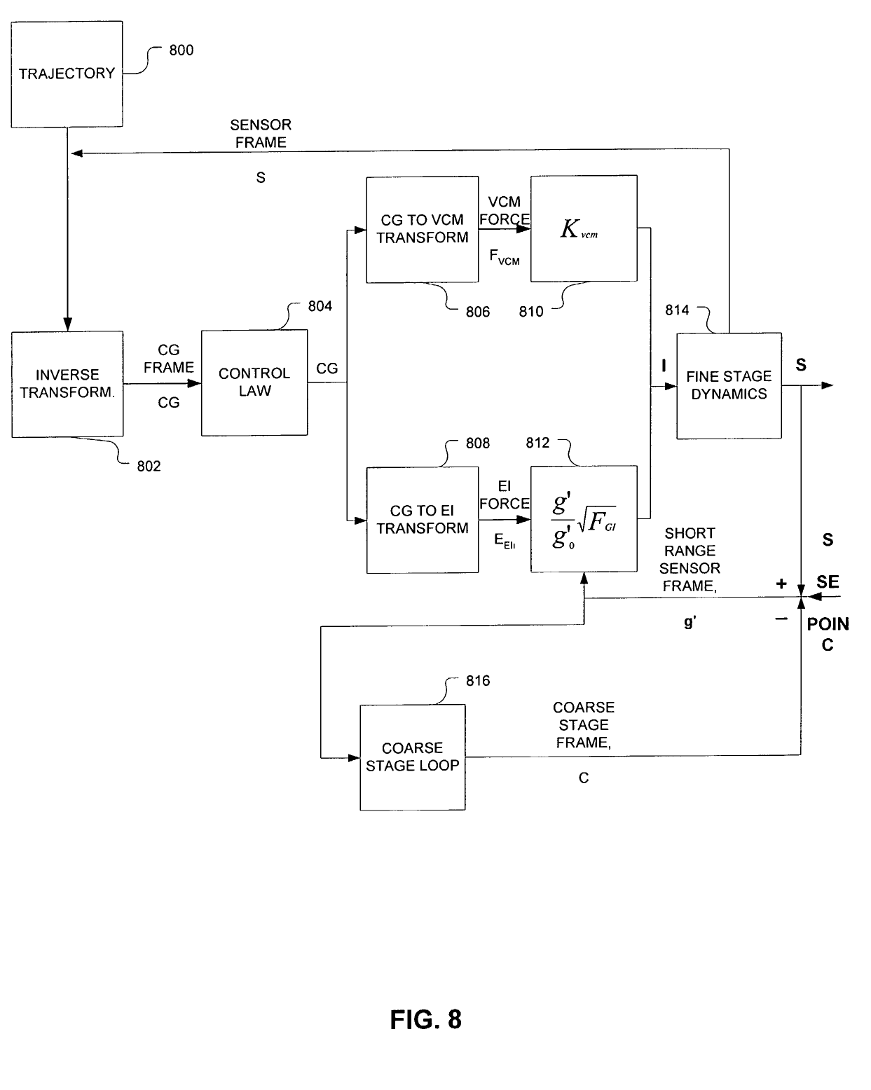

FIG. 8 is a schematic describing the sensing and control functions of the present device. The sensing and control functions are also described in copending U.S. patent application Ser. Nos. 09/022,713 filed Feb. 12, 1998, 09/139,954 filed Aug. 25, 1998, and 09/141,762 filed Aug. 27, 1998, each of which is herein incorporated by reference thereto, in their entireties. A trajectory 800, or desired path for the focused optical system to follow is determined based on the desired path of the wafer or other object to which the focused optical system is to be applied. Trajectory 800 is next fed into the control system. Trajectory 800 is compared with a sensor signal vector S generated from the output of interferometer 88 and focus and level sensor. The difference vector that results from the comparison is transformed to a CG coordinate frame through an inverse transformation 802. A control law 804 prescribes the corrective action for the signal. Control law 804 may be in the form of a PID (proportional integral derivative) controller, proportional gain controller or preferably a lead-lag filter, or other control laws well known in the art of control, for example.

The vector for vertical motion is fed from the CG to VCM transformation 806. This transforms the CG force signal to a value of force to be generated by the VCMs, which is then fed to the VCM 810, and output to the stage hardware 814. The vector for planar motion is also fed to the CG to EI-core transformation 808. This transforms the CG signal to a force to be generated by the EI-core force (i.e., electromagnet and target arrangements 406, 408). Because the EI-core force depends upon the gap squared, it is compensated by the short range sensor vector g′ through the compensation block 812, to produce a linear output to the stage hardware 814. The stage hardware 814 responds to the input and is measured in the sensor frame S. A similar block is not shown in detail below for the coarse stage loop 816. The coarse frame position C, is computed using the fine stage position S and the gap g. This is servoed to follow the fine stage 112.

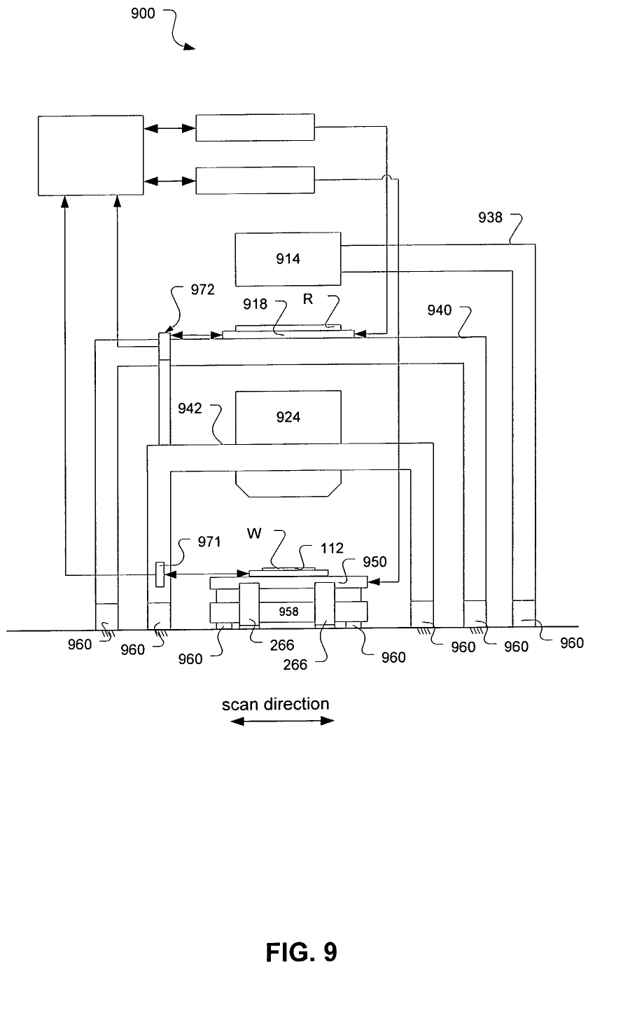

FIG. 9 is a schematic view illustrating an additional embodiment of an exposure apparatus 900 useful with the present invention. A motor 950 (for coarse positioning) for driving fine wafer stage 112 includes a support plate and a coil array (not separately shown). The support plate portion of the motor 950 is supported by a base 958 coupled to the ground by damping means 960, such as air or oil dampers, voice coil motors, actuating portions, or other known vibration isolation systems. The coil array portion of the motor 950 is separately and rigidly coupled to the ground by reaction force supports 266 previously described hereinabove. An illumination system 914, reticle stage 918 and projection optics 924 are respectively supported by an illumination system frame 938, reticle stage frame 940 and projection optics frame 942 which may also be coupled to the ground by similar damping means 960. In this embodiment, when reaction forces are created between the coil array and the wafer stage, the reaction forces push against the ground. Because of the large mass of the ground, there is very little movement of the coil array from the reaction forces. By providing the damping means 960 to couple the base 958 and the illumination system frame 938, the reticle stage frame 940 and the projection optics frame 942 to the ground, any vibration that may be induced by the reaction forces through the ground is isolated from the rest of the exposure apparatus 900.

Additionally, in the embodiment shown in FIG. 9, the reaction force supports 266 may include at least one actuator system that generates a force to cancel the reaction force created between the coil array and the magnet array. By providing the actuator system, the vibration transferred to the ground is decreased. The actuator system may be an actuator that can generate a force in six degrees of freedom (6-degree of freedom). Additional features of the exposure apparatus 900 shown in FIG. 9 include interferometers (position detection devices) 971 and 972 supported by the projection optics frame 942. A first interferometer 971 detects the position of fine stage 112 and outputs the information of the position of the fine stage to a main controller (not shown). A second interferometer 972 detects the position of the reticle stage 918 and outputs the information of the position of the reticle stage 918 to the main controller. The main controller drives fine stage 112 for coarse and /or fine positioning via a wafer drive controller based on the information outputted from the first interferometer 971. Further, the main controller drives the reticle stage 918 via a reticle drive controller based on the information outputted from the second interferometer 972. In this structure, position information of fine stage 112 and reticle stage 918 are unaffected by vibration in fine stage 112 and reticle stage 918, since the interferometers 971 and 972 are isolated with respect to the stages.

The embodiment described in the above example applies principles of the present invention to a wafer stage. However, the present invention can also be applied to a reticle (mask) stage. For example, referring back to FIG. 1, reaction forces generated by movement of the reticle stage 110 can be mechanically released to the ground (floor) by using a support frame member such as the reaction force support 266 previously described. In this case, the support frame member is isolated from the frames 126, 130, 132 and 134, the illumination system 102, the optical system 104, the body 124 and fine stage 112. The stator (coil member or magnet member) of the motor of the reticle stage 110 is fixed to the frame support member.

As described herein, the various embodiments of the present invention have been shown and described such that the actuating portions (electromagnets) of the electromagnetic actuating devices are mounted on the supporting stage and the relative moving portions (targets) of the electromagnetic actuating devices are mounted on the stage (fine stage). However, other arrangements are possible. For example, the actuating portions (electromagnets) could be mounted on the stage (fine stage), and the relative moving portions (targets) could be mounted on the supporting stage.

There are a number of different types of lithographic devices. For example, the exposure apparatus can be used as scanning type exposure device that provides synchronized movement of the mask (reticle) and wafer for exposure of the mask pattern. In such a scanning type device, scanning can be conducted in either the X direction or the Y direction. The scanning type exposure device can be, for example, that disclosed in U.S. Pat. No. 5,473,410. As far as is permitted, the disclosure of U.S. Pat. No. 5,473,410 is incorporated herein by reference.

Alternately, the exposure apparatus can be a step-and-repeat type exposure device that exposes the mask (reticle) while the reticle and the wafer are stationary. In the step and repeat process, the wafer is in a constant position relative to the reticle and the lens assembly during the exposure of an individual field. Subsequently, between consecutive exposure steps, the wafer is consecutively moved by the wafer stage perpendicular to the optical axis of the lens assembly so that the next field of the wafer is brought into position relative to the lens assembly and the reticle for exposure. Following this process, the images on the reticle are sequentially exposed onto the fields of the wafer so that the next field of the wafer is brought into position relative to the lens assembly and the reticle.

However, the use of the exposure apparatus provided herein is not limited to a photolithography system for semiconductor manufacturing. The exposure apparatus, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the invention provided herein can be used in other devices, including other semiconductor processing equipment, machine tools, metal cutting machines, and inspection machines.

The illumination source of the illumination system 102 or 814 can be g-line (436 nm), i-line (365 nm), KrF excimer laser (248 nm), ArF excimer laser (193 nm) and F₂ laser (157 nm). Alternately, the illumination source can also use charged particle beams such as x-ray and electron beam. For instance, in the case where an electron beam is used, thermionic emission type lanthanum hexaboride (LaB6) or tantalum (Ta) can be used as an electron gun. Furthermore, in the case where an electron beam is used, the structure could be such that either a mask is used or a pattern can be directly formed on a substrate without the use of a mask.

In terms of the magnification of the lens assembly of the lens system 104 or the projection optics 924 included in the photolithography system, the lens assembly need not be limited to a reduction system. It could also be a 1× or magnification system.

With respect to a lens assembly, glass materials such as quartz and fluorite that transmit far ultra-violet rays are preferred when far ultra-violet rays such as the excimer laser is used. When the F2 type laser or x-ray is used, the lens assembly should preferably be either catadioptric or refractive (a reticle should also preferably be a reflective type), and when an electron beam is used, electron optics should preferably consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications Disclosure No. 10-20195 and its counterpart U.S. Pat. No. 5,835,257. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference. Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Movement of the stages as described above generates reaction forces that can affect performance of the photolithography system. Reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. No. 5,874,820 and Japanese Patent Application Disclosure No. 8-330224 are incorporated herein by reference.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that accuracy is maintained in the complete photolithography system. Additionally, it is desirable to manufacture an exposure system in a clean room where the temperature and cleanliness are controlled.

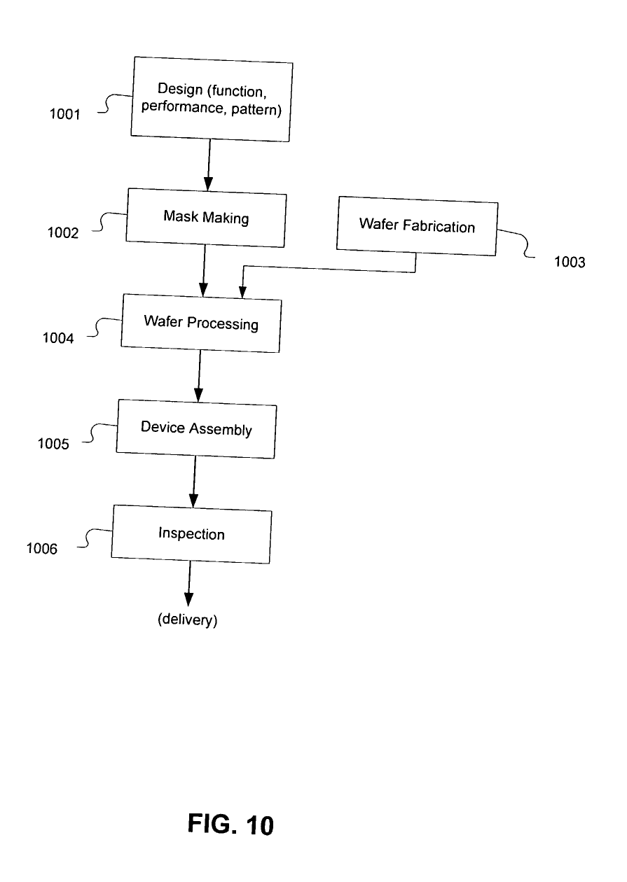

Further, semiconductor devices can be fabricated using the above-described systems, by the process shown generally in FIG. 10. In step 1001 the device's function and performance characteristics are designed. Next, in step 1002, a mask (reticle) having a pattern is designed according to the previous designing step, and in a parallel step 1003 a wafer is made from a silicon material. The mask pattern designed in step 302 is exposed onto the wafer from step 1003 in step 1004 by a photolithography system described hereinabove in accordance with the present invention. In step 1005 the semiconductor device is assembled (including the dicing process, bonding process and packaging process), and then finally the device is inspected in step 1006.

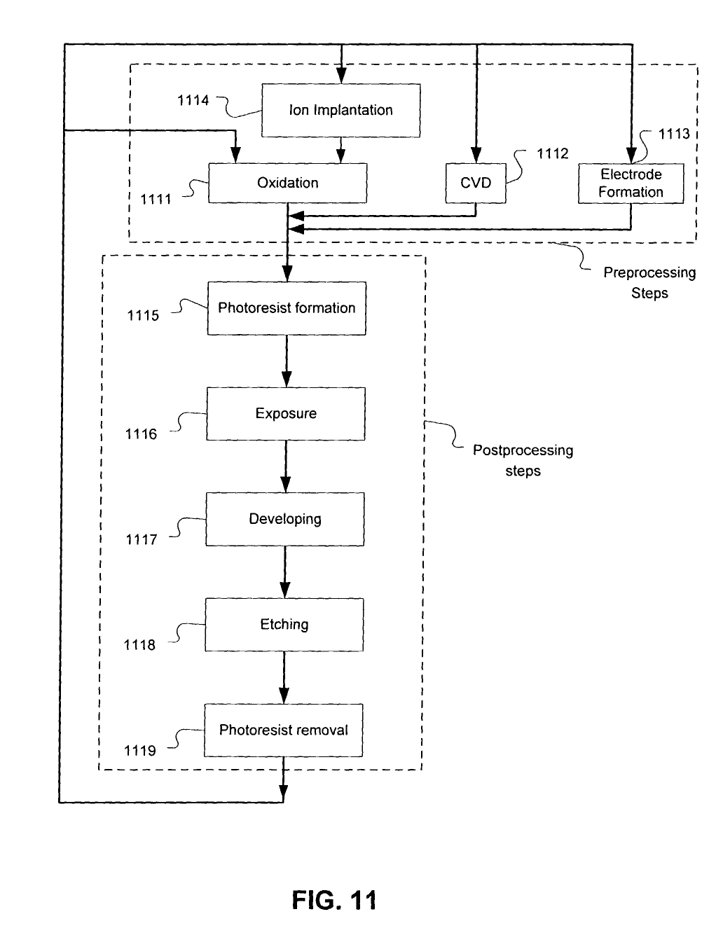

FIG. 11 illustrates a detailed flowchart example of the above-mentioned step 304 in the case of fabricating semiconductor devices. In FIG. 11, in step 1111 (oxidation step), the wafer surface is oxidized. In step 1112 (CVD step), an insulation film is formed on the wafer surface. In step 1113 (electrode formation step), electrodes are formed on the wafer by vapor deposition. In step 1114 (ion implantation step), ions are implanted in the wafer. The above mentioned steps 1111-1114 form the preprocessing steps for wafers during wafer processing, and selection is made at each step according to processing requirements.

At each stage of wafer processing, when the above-mentioned preprocessing steps have been completed, the following post-processing steps are implemented. During post-processing, firstly, in step 1115 (photoresist formation step), photoresist is applied to a wafer. Next, in step 1116, (exposure step), the above-mentioned exposure device is used to transfer the circuit pattern of a mask (reticle) to a wafer. Then, in step 1117 (developing step), the exposed wafer is developed, and in step 1118 (etching step), parts other than residual photoresist (exposed material surface) are removed by etching. In step 1119 (photoresist removal step), unnecessary photoresist remaining after etching is removed.

Multiple circuit patterns are formed by repetition of these preprocessing and post-processing steps. It is to be understood that a photolithographic instrument may differ from the one shown herein without departing from the scope of the present invention. For example, it is to be understood that the bearings and drivers of an instrument may differ from those shown herein without departing from the scope of the present invention. It is also to be understood that the application of the present invention is not to be limited to a wafer processing apparatus. While embodiments of the present invention have been shown and described, changes and modifications to these illustrative embodiments can be made without departing from the present invention in its broader aspects, described in the appended claims.

Accordingly, the invention is not limited to the above-described implementations, but instead is defined by the appended claims in light of their full scope of equivalents.

What is claimed is:

1. A support device providing flexibility in at least two degrees of freedom, comprising:
a mounting device with stiffness in at least a first degree of freedom and rotational flexibility in a second degree of freedom, capable of receiving a stage device; and
an extension device configured to extend from a base and affix to the mounting device wherein the extension device has flexibility in at least the first degree of freedom and rotational stiffness in the second degree of freedom.

2. The support device in claim 1 wherein the stage device is used in conjunction with lithographic processing.

3. The support device of claim 1, wherein the rotational flexibility in the mounting device is facilitated using at least two flexures arranged at angles to each other and capable of providing rotational flexibility in the second degree of freedom and stiffness in at least the first degree of freedom.

4. The support device of claim 3, wherein the at least two flexures used by the mounting device are arranged at substantially orthogonal positions to each other.

5. The support device of claim 3, wherein each flexure is affixed substantially orthogonal to each other and to the mounting device and comprises a plane of material having lateral stiffness and planar flexibility.

6. The support device of claim 5, wherein the plane of material comprises a metallic material.

7. The support device of claim 5, wherein the plane of material comprises a non-metallic material.

8. The support device of claim 1, wherein the rotational flexibility in the mounting device is facilitated using a rotational air-bearing capable of providing rotational flexibility in the second degree of freedom and stiffness in at least the first degree of freedom.

9. The support device of claim 1, wherein the extension device designed to extend from the base and affix to the mounting device is capable of providing a force substantially aligned along the axis associated with the second degree of freedom.

10. The support device of claim 1, wherein the extension device designed to extend from the base and affix to the mounting device is capable of providing a vertical force substantially aligned along the axis associated with the second degree of freedom.

11. The support device of claim 1, wherein the extension device designed to extend from the base and affix to the mounting device comprises a bellows capable of providing a force substantially along the axis associated with the second degree of freedom with relative rotational stiffness substantially around the axis associated with the second degree of freedom and flexibility in at least the first degree of freedom.

12. The support device of claim 1, wherein the extension device designed to extend from the base and affix to the mounting device comprises a bellows capable of providing a force responsive to air-pressure.

13. The support device of claim 1, wherein the extension device designed to extend from the base and affix to the mounting device comprises a spring mechanism capable of providing a force substantially along the axis associated with the second degree of freedom and relative rotational stiffness substantially around the axis associated with the second degree of freedom and flexibility in at least the first degree of freedom.

14. The support device of claim 1, wherein the extension device designed to extend from the base and affix to the mounting device comprises a diaphram capable of providing a force substantially along the axis associated with the second degree of freedom with relative rotational stiffness substantially around the axis associated with the second degree of freedom and flexibility in at least the first degree of freedom.

15. A lithography system comprising:
an illumination system that irradiates radiant energy; and
the support device according to claim 1, said support device is configured to support a stage device on a path of said radiant energy.

16. The lithography system of claim 15, further comprising an optical system and the stage device substantially aligned with the optical system.

17. The lithography system of claim 15, further comprising a mask stage that holds a mask having a pattern, and the mask is positioned between the illumination system and the stage.

18. The lithography system of claim 15, further comprising a frame that supports at least one of the illumination system and the optical system, and is dynamically isolated from the stage device.

19. The lithography system of claim 15, wherein the optical system is positioned between the mask and the stage.

20. A device on which an image has been formed by the lithography system of claim 15.

21. A method of making a support device comprising: providing a mounting device with stiffness in at least a first degree of freedom and rotational flexibility in a second degree of freedom, capable of receiving a stage device; and
providing an extension device extending from a base and affixing to the mounting device wherein the extension device has flexibility in at least the first degree of freedom and rotational stiffness in the second degree of freedom.

22. A method of making a lithography system comprising:
providing an illumination system that irradiates radiant energy; and
providing a support device made by the method of claim 21.

23. A method of making a device utilizing the lithography system made by the method of claim 22.

24. A method of supporting a stage with a supporting device comprising:
affixing the stage to a mounting device with stiffness in at least a first degree of freedom and rotational flexibility in a second degree of freedom; and
extending an extension device from a base and affix to the mounting device wherein the extension device has flexibility in at least the first degree of freedom and rotational stiffness in the second degree of freedom.

25. An exposure method for forming a pattern on a device utilizing an optical system, comprising:
mounting the device onto a stage;
moving a stage substantially aligned with the optical system; and
supporting the stage with a mounting device having stiffness in at least a first degree of freedom and rotational flexibility in a second degree of freedom, and an extension device configured to extend from a base and affix to the mounting device wherein the extension device has flexibility in at least the first degree of freedom and rotational stiffness in the second degree of freedom.

26. A support device providing flexibility in at least two degrees of freedom comprising:
a mounting device with stiffness in at least a first degree of freedom while providing rotational flexibility in a second degree of freedom and capable of receiving a stage device; and
a bellows extension device configured to extend from a base and affix to the mounting device having flexibility in at least the first degree of freedom and rotational stiffness in the second degree of freedom.

27. The support device in claim 26 wherein the stage device capable of being received by the mounting device is used in lithographic processing.

28. The support device of claim 26, wherein the rotational flexibility in the mounting device is facilitated using at least two flexures arranged at angles to each other providing rotational flexibility in the second degree of freedom and stiffness in at least the first degree of freedom.

29. The support device of claim 26, wherein the rotational flexibility in the mounting device is facilitated using at least four flexures arranged at angles to each other providing rotational flexibility in the second degree of freedom and stiffness in at least the first degree of freedom.

30. The support device of claim 28, wherein each flexure is affixed substantially orthogonal to each other and the mounting device and comprises a plane of material having lateral stiffness and planar flexibility.

31. The support device of claim 28, wherein the plane of material comprises a metallic material.

32. The support device of claim 28, wherein the plane of material comprises a non-metallic material.

33. The support device of claim 26, wherein the rotational flexibility in the mounting device is facilitated using a rotational air-bearing capable of providing rotational flexibility in the second degree of freedom and stiffness in at least the first degree of freedom.

34. The support device of claim 26, wherein the bellows extension device designed to extend from a base and affix to the mounting device is capable of providing a force substantially aligned along the axis associated with the second degree of freedom.

35. The support device of claim 26, wherein the bellows extension device designed to extend from a base and affix to the mounting device is capable of providing a vertical lifting force substantially aligned along the axis associated with the second degree of freedom.

36. The support device of claim 26, wherein the bellows extension device designed to extend from a base and affix to the mounting device is capable of extending and providing a force responsive to air-pressure.

37. A support device providing flexibility in at least two degrees of freedom comprising:
a mounting device using at least two flexures affixed orthogonal to each other and to the mounting device and capable of receiving a stage device wherein the mounting device is capable of providing provides rotational flexibility in a second degree of freedom and stiffness in at least a first degree of freedom; and
a bellows extension device designed to extend from a base and affix to the mounting device having flexibility in at least the first degree of freedom and rotational stiffness in the second degree of freedom.

38. The support device in claim 37 wherein the stage device capable of being affixed to the mounting device is used in conjunction with lithographic processing.

39. The support device of claim 37, wherein each flexure comprises a plane of material having lateral stiffness and planar flexibility.

40. The support device of claim 39, wherein the plane of material comprises a metallic material.

41. The support device of claim 39, wherein the plane of material comprises a flexible and non-metallic material.

42. The support device of claim 37, wherein the bellows extension device affixed to the mounting device is capable of providing a force substantially aligned along the axis associated with the second degree of freedom.

43. The support device of claim 37, wherein the bellows extension device affixed to the mounting device is capable of providing a vertical lifting force substantially aligned along the axis associated with the second degree of freedom.

44. The support device of claim 42, wherein the bellows extension device affixed to the mounting device is capable of providing force in response to air-pressure.

45. The support device of claim 29, wherein each flexure is affixed substantially orthogonal to each other and the mounting device and comprises a plane of material having lateral stiffness and planar flexibility.

46. The support device of claim 29, wherein the plane of material comprises a metallic material.

47. The support device of claim 29, wherein the plane of material comprises a non-metallic material.
